(19) United States
(12) Patent Application Publication
(10) Pub. No.: US 2022/0098995 A1
(43) Pub. Date: Mar. 31, 2022

(54) GAS-TURBINE-ENGINE OVERSPEED PROTECTION SYSTEM

(71) Applicant: WILLIAMS INTERNATIONAL CO., L.L.C., Pontiac, MI (US)

(72) Inventors: Thomas J. WILLIAMS, Milford Township, MI (US); Mark E. SUCHEZKY, Fenton, MI (US); Jeffrey C. THOMPSON, Commerce Township, MI (US)

(73) Assignee: WILLIAMS INTERNATIONAL CO., L.L.C., Pontiac, MI (US)

(21) Appl. No.: 17/383,372

(22) Filed: Jul. 22, 2021

Related U.S. Application Data
(60) Provisional application No. 63/055,556, filed on Jul. 23, 2020.

(51) Int. Cl. F01D 17/16; F01D 21/02

(52) U.S. Cl. CPC F01D 17/162; F01D 21/02; F05D 2260/4023; F05D 2260/4031; F05D 2260/50; F05D 2270/09; F05D 2270/304; F05D 2270/62; F05D 2270/021

(57) ABSTRACT

A rotational position of a variable-vane of a variable-vane turbine nozzle upstream of a turbine of a gas-turbine engine is biased towards a corresponding rotational position that will mitigate against an overspeed condition of the turbine during operation of the gas-turbine engine. When the turbine is operating at a rotational speed that is less than an overspeed threshold, the rotational position of the variable-vane is controlled independently of the biasing using a variable-vane actuator operatively coupled to the variable-vane. Responsive to a rotational speed of the turbine in excess of the overspeed threshold, the variable-vane actuator is operatively decoupled from the variable-vane so as to provide for the variable-vane to be repositioned towards the corresponding rotational position that will mitigate against the overspeed condition.

### CROSS-REFERENCE TO RELATED APPLICATIONS

The instant application claims the benefit of prior U.S. Provisional Application Ser. No. 63/055,556 filed on 23 Jul. 2020, which is incorporated herein by reference in its entirety.

### BRIEF DESCRIPTION OF THE DRAWINGS

In the accompanying drawings:

FIG. 1 illustrates a schematic diagram of a gas-turbine-engine overspeed protection system;

FIGS. 2a and 2b respectively illustrate front and aft isometric views of a first embodiment of a third aspect of a gas-turbine-engine overspeed protection system in cooperation with variable-vane turbine nozzle system;

FIGS. 3a and 3b illustrate respective front and aft isometric views of the first-embodiment, third-aspect gas-turbine-engine overspeed protection system in cooperation with the variable-vane turbine nozzle system as in FIGS. 2a and 2b, but absent the associated nozzle housing, with the associated plurality of variable nozzle vanes in a metering rotational position as illustrated in FIG. 9a;

FIG. 4 illustrates a longitudinal cross-sectional view of the first-embodiment, third-aspect gas-turbine-engine overspeed protection system in cooperation with the variable-vane turbine nozzle system illustrated in FIGS. 2a through 3b;

FIG. 5a illustrates a fragmentary portion of the longitudinal cross-section illustrated in FIG. 4 during normal operation of the gas-turbine engine prior to an overspeed condition of the power turbine of the gas-turbine engine;

FIG. 5b illustrates a fragmentary portion of the longitudinal cross-section illustrated in FIG. 4 following an overspeed condition of the power turbine of the gas-turbine engine;

FIG. 6a illustrates an isometric view of the variable-vane actuator and an associated spline-shaft-driven gear mechanism of the associated decoupling mechanism absent an associated swivel, during normal operation of the gas-turbine engine prior to an overspeed condition of the power turbine of the gas-turbine engine;

FIG. 6b illustrates an isometric view of the variable-vane actuator and an associated spline-shaft-driven gear mechanism of the associated decoupling mechanism absent an associated swivel, following an overspeed condition of the power turbine of the gas-turbine engine;

FIG. 7a illustrates an aft isometric view of the first-embodiment, third-aspect gas-turbine-engine overspeed protection system in cooperation with the variable-vane turbine nozzle system illustrated in FIGS. 2a and 4, further illustrating an associated first aspect spring-based biasing element in cooperation with an associated nozzle-vane-angle control mechanism, during normal operation of the gas-turbine engine prior to an overspeed condition of the power turbine of the gas-turbine engine;

FIG. 7b illustrates an aft isometric view of the first-embodiment, third-aspect gas-turbine-engine overspeed protection system in cooperation with the variable-vane turbine nozzle system illustrated in FIGS. 2a and 4, in cooperation with the associated first aspect spring-based biasing element in cooperation with an associated nozzle-vane-angle control mechanism, following an overspeed condition of the power turbine of the gas-turbine engine;

FIG. 8a illustrates an aft view of the first-embodiment, third-aspect gas-turbine-engine overspeed protection system in cooperation with the variable-vane turbine nozzle system illustrated in FIGS. 2a and 4, in cooperation with the associated first aspect spring-based biasing element in cooperation with an associated nozzle-vane-angle control mechanism, during normal operation of the gas-turbine engine prior to an overspeed condition of the power turbine of the gas-turbine engine;

FIG. 8b illustrates an aft view of the first-embodiment, third-aspect gas-turbine-engine overspeed protection system in cooperation with the variable-vane turbine nozzle system illustrated in FIGS. 2a and 4, in cooperation with the associated first aspect spring-based biasing element in cooperation with an associated nozzle-vane-angle control mechanism, following an overspeed condition of the power turbine of the gas-turbine engine;

FIG. 9a illustrates a variable-vane turbine nozzle upstream of an associated power turbine of a gas-turbine engine, with the variable nozzle vanes of the variable-vane turbine nozzle in a rotationally positioned by an associated variable-vane actuator for metering exhaust gases during normal operation of the gas-turbine engine;

FIG. 9b illustrates a variable-vane turbine nozzle upstream of an associated power turbine of a gas-turbine engine, with the variable nozzle vanes of the variable-vane turbine nozzle rotationally positioned by an associated biasing element so as provide for the power turbine to generate a relatively-reverse torque relative to normal operation of the gas-turbine engine, so as to mitigate against an overspeed of the power turbine;

FIG. 10 illustrates a trigger system and associated trigger mechanism of a decoupling mechanism incorporated in the first-embodiment, third-aspect gas-turbine-engine overspeed protection system in cooperation with the variable-vane turbine nozzle system illustrated in FIGS. 2a through 3b;

FIG. 11a illustrates a cross-sectional view of the trigger mechanism illustrated in FIG. 10, with the associated trigger mechanism latched during normal operation of the gas-turbine engine;

FIG. 11b illustrates a cross-sectional view of the trigger mechanism illustrated in FIG. 10, with the associated trigger mechanism unlatched following an overspeed condition of the power turbine of the gas-turbine engine;

FIG. 12 illustrates a variable-vane turbine nozzle upstream of an associated power turbine of a gas-turbine engine, with the variable nozzle vanes of the variable-vane turbine nozzle rotationally positioned in a fully-open position by an associated biasing element so as to mitigate against an overspeed of the power turbine; and

FIG. 13 illustrates a variable-vane turbine nozzle upstream of an associated power turbine of a gas-turbine engine, with the variable nozzle vanes of the variable-vane turbine nozzle rotationally positioned in a fully-closed position by an associated biasing element so as to mitigate against an overspeed of the power turbine.

### DESCRIPTION OF EMBODIMENT(S)

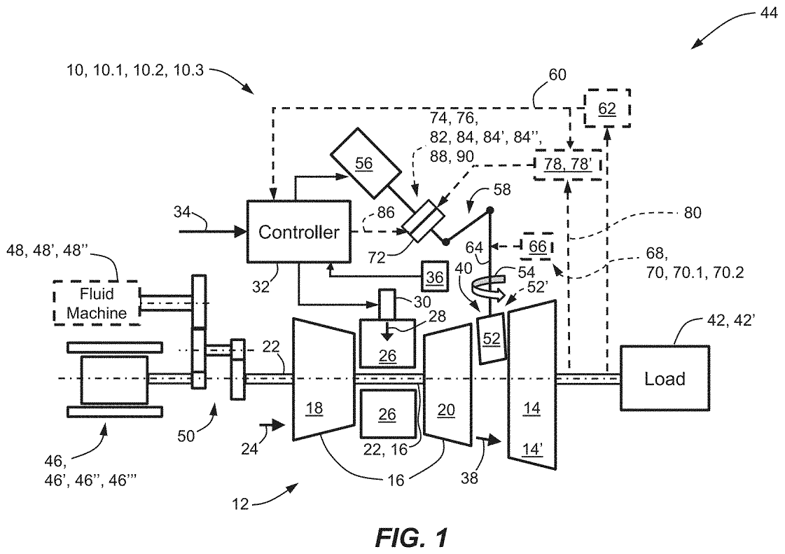

Referring to FIG. 1, a gas-turbine-engine overspeed protection system 10 is incorporated in a gas-turbine engine 12 to provide for preventing an overspeed condition of an associated power turbine 14 thereof during operation of the gas-turbine engine 12. More particularly, the gas-turbine engine 12 comprises a gasifier spool 16 that incorporates a compressor 18 and gasifier turbine 20 that are interconnected via an associated spool shaft 22. During operation, external air 24 is compressed by the compressor 18 and combusted in an associated combustion chamber 26 with fuel 28 injected thereinto by an associated fuel delivery system 30 under control of an associated controller 32, responsive to user control input(s) 34 and responsive to the associated operating condition of the gas-turbine engine 12 as sensed by one or more associated engine sensors 36. Resulting exhaust gases 38 generated in the combustion chamber 26 initially drive the gasifier turbine 20, which in turn drives the compressor 18 via the associated spool shaft 22, after which the exhaust gases 38 exit the gasifier turbine 20 through an associated variable-vane turbine nozzle 40 to drive the power turbine 14, the latter of which is used to drive an associated load 42. For example, in one set of embodiments, the gas-turbine engine 12 is incorporated an Auxiliary Power Unit (APU) 44, for example, with the load 42 comprising an associated main electrical generator 42′ capable of generating a substantial amount of electrical power from a corresponding substantial amount of mechanical shaft power generated by the power turbine 14. In accordance with an additional set of embodiments, the Auxiliary Power Unit (APU) 44 may also incorporate a power takeoff from the spool shaft 22 of the gasifier spool 16, for example, to drive an electrical machine 46 and or a fluid machine 48, for example, operatively coupled to the spool shaft 22 via an associated gearbox 50, or directly coupled thereto, particularly in the case of the electrical machine 46. For example, the electrical machine 46 may comprise either a starter 46′ to provide for starting the gas-turbine engine 12, a generator 46″ to provide for local generation of electrical power, or a starter-generator 46′″ to provide for both. Furthermore, the fluid machine 48 may comprise either a hydraulic machine 48′ or a pneumatic machine 48″, either of which could be configured as either a pump to generate fluid power, a motor to provide for starting the gas-turbine engine 12, or a combination of a motor and a pump.

The variable-vane turbine nozzle 40 incorporates one or more variable nozzle vanes 52 that control the direction at which the exhaust gases 38 discharging therefrom impinge on the blades 14′ of the power turbine 14, wherein this direction is controlled by controlling the corresponding rotational position 54 of each of the one or more variable nozzle vanes 52. During normal operation of the gas-turbine engine 12, the rotational positions 54 of each of the one or more variable nozzle vanes 52 are controlled—typically in synchronism, typically uniformly—by an associated variable-vane actuator 56 via an associated nozzle-vane-angle control mechanism 58 that operatively couples the variable-vane actuator 56 to each of the one or more variable nozzle vanes 52, so as to provide for adjusting the associated rotational positions 54 of the one or more variable nozzle vanes 52 responsive to the particular operating conditions of the gas-turbine engine 12, and responsive to the associated user control input(s) 34, so as to generate with the power turbine 14 a corresponding appropriate level of shaft torque or shaft power that is applied to, and absorbed by, the load 42.

During operation of the gas-turbine engine 12/Auxiliary Power Unit (APU) 44, if the power demanded by the load 42 is reduced—particularly if reduced suddenly—thereby reducing or suddenly reducing the shaft torque transmitted to the load 42 by the power turbine 14, the exhaust gases 38 impinging on the blades 14′ of the power turbine 14 will accelerate the power turbine 14, which absent further action may result in excessive rotational speed of the power turbine 14, i.e. an associated overspeed condition. In one set of embodiments, this overspeed condition can be avoided by quickly reconfiguring the rotational positions 54 of the one or more variable nozzle vanes 52 of the variable-vane turbine nozzle 40—each associated rotational position 54 referred to herein as an “overspeed-mitigating rotational position”—so as to redirect the stream of exhaust gases 38 impinging on the blades 14′ of the power turbine 14 so as to either provide for reducing the magnitude of the torque generated by the impingement of exhaust gases 38 on the blades 14′ of the power turbine 14, and/or to provide for generating a reverse torque on—and a resulting deceleration of—the power turbine 14.

In accordance with a first aspect 10.1 of the gas-turbine-engine overspeed protection system 10, 10.1, one or more of the variable-vane actuator 56, nozzle-vane-angle control mechanism 58, and the associated one or more variable nozzle vanes 52 of the variable-vane turbine nozzle 40 are configured by a variable-vane actuator 56 with sufficient authority to sufficiently-quickly reposition each of the associated one or more variable nozzle vanes 52 to an overspeed-mitigating rotational position so as to prevent an associated overspeed condition of the power turbine 14, responsive to the rotational speed of the power turbine 14, for example, responsive to a rotational speed signal 60 from a rotational speed sensor 62 operatively associated with the power turbine 14, and operatively coupled to the controller 32.

In accordance with a second aspect 10.2 of a gas-turbine-engine overspeed protection system 10, 10.2, each of the one or more variable nozzle vanes 52, 52′ of the variable-vane turbine nozzle 40 are configured to be inherently biased towards the associated overspeed-mitigating rotational position by action of the exhaust gases 38 impinging thereon. For example, in one set of embodiments, variable nozzle vanes 52, 52′ are configured to swing about an axis of rotation 64 that is approximately normal to the flow of exhaust gases 38, with each variable nozzle vane 52, 52′ shaped and positioned relative to the corresponding axis of rotation 64 so that the resulting center of pressure acts to rotate the variable nozzle vane 52, 52′ towards the associated overspeed-mitigating rotational position, the latter of which may be defined by an associated rotational-position-limiting mechanical stop. For example, in one set of embodiments, the rotational-position-limiting mechanical stop provides for each of the one or more variable nozzle vanes 52, 52′ to be rotated by the flow of the exhaust gases 38 to a relatively open position as the overspeed-mitigating rotational position, which limits the associated work that can be done by the power turbine 14, so as to prevent an overspeed thereof.

In accordance with a third aspect 10.3, the gas-turbine-engine overspeed protection system 10, 10.3 incorporates a biasing element 66 operatively coupled to the one or more variable nozzle vanes 52—for example, via the associated nozzle-vane-angle control mechanism 58—that provides for biasing each of the one or more variable nozzle vanes 52 towards a corresponding associated overspeed-mitigating rotational position, wherein the variable-vane actuator 56 has sufficient authority to overcome the associated biasing force—and thereby control the rotational positions of the one or more variable nozzle vanes 52—during normal operation of an associated gas-turbine engine 12 that is not experiencing an associated overspeed condition. For example, in one set of embodiments, the associated biasing force is generated by a spring 68 operative between the nozzle-vane-angle control mechanism 58 and a fixed portion of the gas-turbine engine 12, i.e. a mechanical ground. As another example, in another set of embodiments, the associated biasing force is generated by a fluid-powered actuator 70 for example, either a pneumatic cylinder 70.1 or a hydraulic cylinder 70.2, operative between the nozzle-vane-angle control mechanism 58 and the mechanical ground.

The second and third aspect gas-turbine-engine overspeed protection systems 10, 10.2, 10.3 further incorporate a decoupling mechanism 72 that provides for decoupling the variable-vane actuator 56 from the one or more variable nozzle vanes 52—for example, by providing for decoupling the variable-vane actuator 56 from the associated nozzle-vane-angle control mechanism 58 interposed therebetween—so as to provide for each of the one or more variable nozzle vanes 52 to be rotated to the associated overspeed-mitigating rotational position responsive to the above-described biasing element 66 following a decoupling of the variable-vane actuator 56 responsive to the detection of an associated overspeed condition of the power turbine 14. For example, in one set of embodiments, the decoupling mechanism 72 incorporates a decouplable spline-shaft-driven gear mechanism 74—incorporating at least one spline coupling 76—that is mechanically actuated, i.e. decoupled, by an associated mechanically-actuated trigger system 78 that is inherently responsive to the rotational speed 80 of either the power turbine 14 or a shaft operatively coupled thereto. As another example, in accordance with another set of embodiments, the decoupling mechanism 72 incorporates a releasable mechanical clutch 82, for example, rotationally in series with a drive shaft of the variable-vane actuator 56 and actuated either responsive to an associated mechanically-actuated trigger system 78, the latter of which is inherently responsive to the rotational speed 80 of either the power turbine 14 or a shaft operatively coupled thereto, or responsive to a solenoid-actuated trigger system 78′, the latter of which may be actuated responsive to a rotational-speed actuated switch responsive to the rotational speed 80 of either the power turbine 14 or a shaft operatively coupled thereto, or responsive to a rotational speed signal 60 from the rotational speed sensor 62. As yet another example, in accordance with yet another set of embodiments, the decoupling mechanism 72 incorporates a releasable electro-mechanical clutch 84, for example, rotationally in series with a drive shaft of the variable-vane actuator 56, and actuated responsive to an associated mechanically-actuated trigger system 78, the latter of which may be responsive to the rotational speed signal 60 from the rotational speed sensor 62, either under direct control or via an associated actuation signal 86 from the controller 32. For example, in one set of embodiments, the releasable electro-mechanical clutch 84, 84′ is engaged responsive to a holding current in one or more associated coils, and disengaged when that holding current is interrupted. As another example, in another set of embodiments, the releasable electro-mechanical clutch 84, 84″ is normally held in engagement by one or more permanent magnets incorporated therein, and disengaged responsive to a current applied to one or more coils that provide for canceling the magnetic field(s) of the associated one or more permanent magnets. As yet another example, in accordance with yet another set of embodiments, the decoupling mechanism 72 incorporates at least one frangible link 88—for example, either rotationally in series with the variable-vane actuator 56, or axially in series with a link driven thereby—that, when severed, for example, responsive to actuation of a corresponding associated at least one pyrotechnic device 90, provides for decoupling the variable-vane actuator 56 from the one or more variable nozzle vanes 52.

Accordingly, under normal operation of the gas-turbine engine 12 with the power turbine 14 not subject to an overspeed condition, the variable-vane actuator 56 provides for controlling the rotational position of each of the one or more variable nozzle vanes 52, 52′ of the variable-vane turbine nozzle 40, so as to provide for controlling the direction and/or flow rate of the associated exhaust gases 38 from the gasifier spool 16, thereby providing for generating sufficient power to drive the associated load 42, 42′. However, if the load 42, 42′ becomes suddenly reduced or disconnected from the power turbine 14,—for example, as a result of a sudden reduction of load current from an associated main electrical generator 42′, for example, as a result of a break in the associated load circuit or an associated equipment failure,—if the controller 32 cannot respond sufficiently quickly to reduce the flow of fuel 28 to the gas-turbine engine 12, the exhaust gases 38 that continue to be generated by the gasifier spool 16 will tend to drive the power turbine 14 towards an overspeed condition, responsive to which, upon detection of the overspeed condition, the associated decoupling mechanism 72 is actuated so as to decouple the variable-vane actuator 56 from the associated one or more variable nozzle vanes 52, 52′, and thereby provide for each of the associated one or more variable nozzle vanes 52, 52′ to be biased towards the corresponding associated overspeed-mitigating rotational position either responsive to aerodynamic forces from the exhaust gases 38 acting on the one or more variable nozzle vanes 52, 52′ in accordance with the second aspect gas-turbine-engine overspeed protection system 10, 10.2; or responsive to the associated biasing element 66 acting on the one or more variable nozzle vanes 52, 52′, either directly, or via the associated nozzle-vane-angle control mechanism 58, in accordance with the third aspect gas-turbine-engine overspeed protection system 10, 10.3.

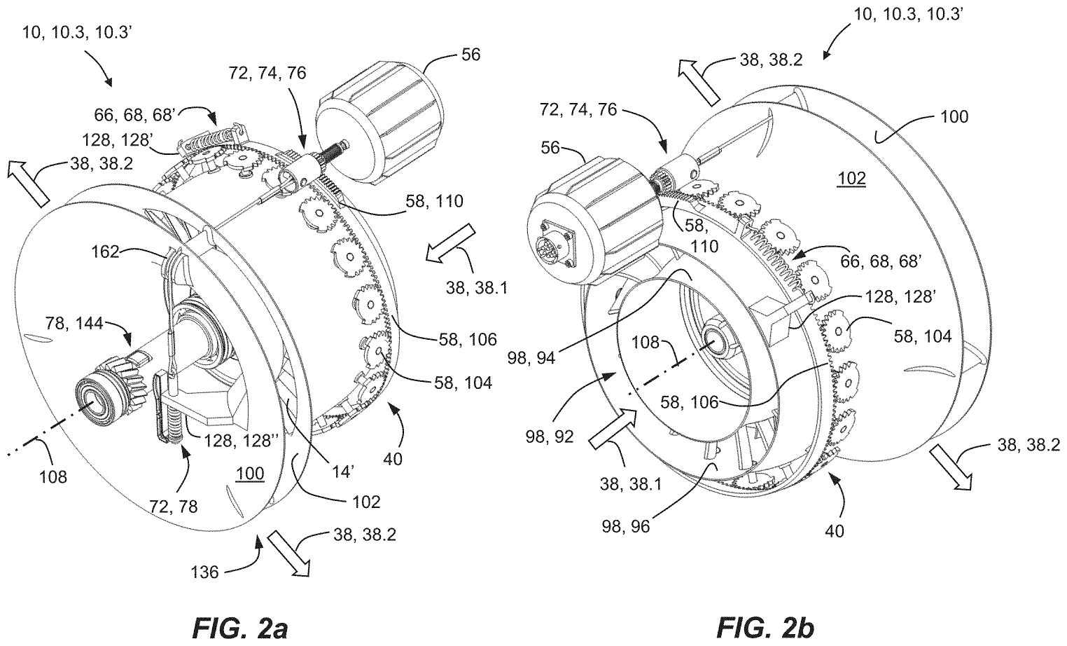

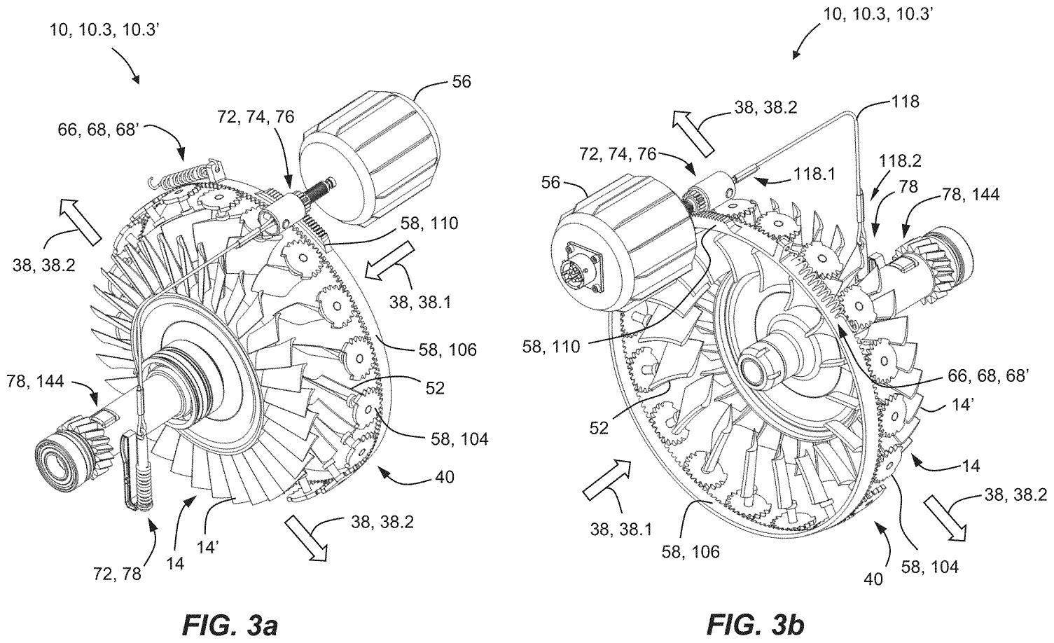

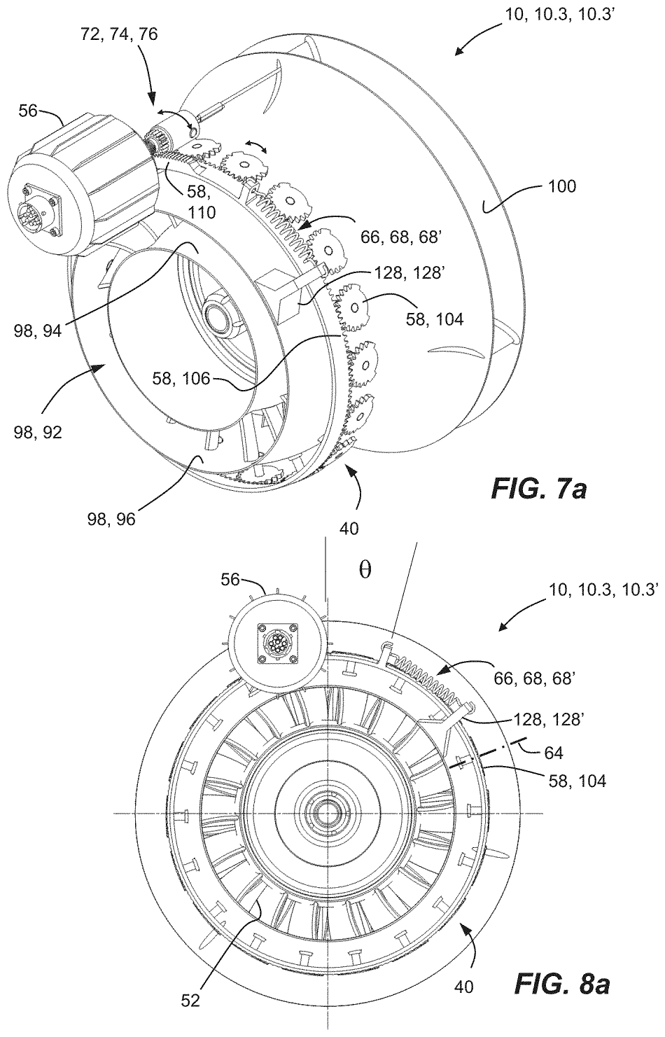

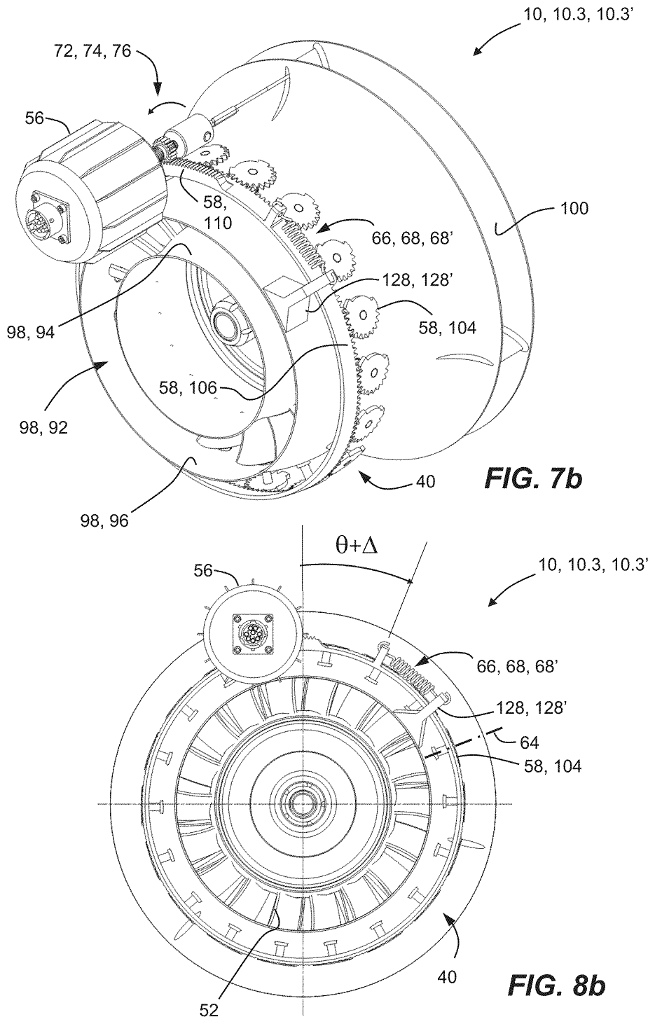

Referring to FIGS. 2a through 11b, a first embodiment of the third aspect gas-turbine-engine overspeed protection system 10, 10.3, 10.3′ is configured in cooperation with a variable-vane turbine nozzle 40 incorporating a plurality of variable nozzle vanes 52 that are substantially-uniformly circumferentially distributed around an associated annulus 92 between the inner 94 and outer 96 walls of a duct 98 through which exhaust gases 38 are directed from a gasifier turbine 20 to a power turbine 14 of an associated gas-turbine engine 12, wherein the inner 94 and outer 96 walls are respectively associated with the hub 100 and shroud 102 of the power turbine 14, the exhaust gases 38, 38.1 are received in a generally axial direction from the gasifier turbine 20, and the hub 100 and shroud 102 in the illustrated embodiment is shaped so as to discharge the exhaust gases 38, 38.2 in a generally radial direction. Each variable nozzle vane 52 of the plurality of variable nozzle vanes 52 is configured to rotate about a substantially radially-oriented axis of rotation 64 responsive to rotation of an associated sector gear 104, wherein each sector gear 104 of each of the plurality of variable nozzle vanes 52 engages with an axial ring gear 106, the latter of which is engaged with each of the sector gears 104 of each of the plurality of variable nozzle vanes 52, wherein the axial ring gear 106 incorporates axially-oriented gear teeth and extends around, and is configured to rotate about, the longitudinal axis 108 of the power turbine 14, wherein a rotation of the axial ring gear 106 about the longitudinal axis 108 causes corresponding rotations of each of the plurality of variable nozzle vanes 52 and associated sector gears 104 about the corresponding associated radially-oriented axes of rotation 64 of the plurality of variable nozzle vanes 52. The axial ring gear 106 incorporates an external ring-gear sector 110 that engages with a spline-shaft-driven gear mechanism 74 that is operatively coupled to an associated variable-vane actuator 56 via at least one spline coupling 76, wherein a spur gear 112 of the spline-shaft-driven gear mechanism 74 is continuously engaged with the external ring-gear sector 110, and a hub shaft 114 is continuously coupled via a first spline coupling 76.1 to a drive shaft 116 of the variable-vane actuator 56 and controllably coupled via a second spline coupling 76.2 to the spur gear 112. The hub shaft 114 is operatively coupled to a first end 118.1 of a control cable 118 with a swivel 120, the latter of which is axially-retained on the hub shaft 114 by a retaining nut 122 fastened to a first end of the hub shaft 114, but which provides for the hub shaft 114 to rotate with respect to the swivel 120. A compression spring 124 operative between a face of the spur gear 112 and a flange 126 depending from the second end of the hub shaft 114 provides for biasing the engagement of the hub shaft 114 with the spur gear 112 via the second spline coupling 76.2. Accordingly, the sector gears 104 associated with each of the plurality of variable nozzle vanes 52, the axial ring gear 106 operatively coupled thereto, and the external ring-gear sector 110 operatively coupled to the spline-shaft-driven gear mechanism 74 constitute an associated nozzle-vane-angle control mechanism 58 that provides for operatively coupling the variable-vane actuator 56 to each of the plurality of variable nozzle vanes 52.

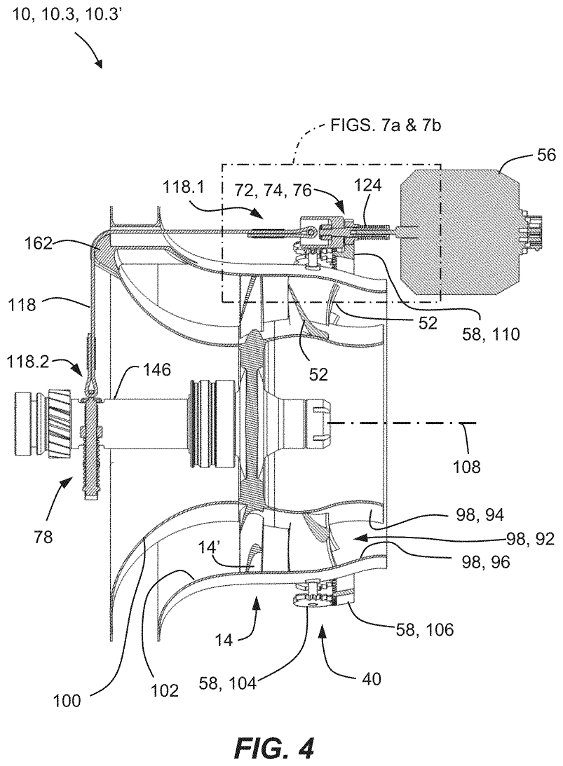

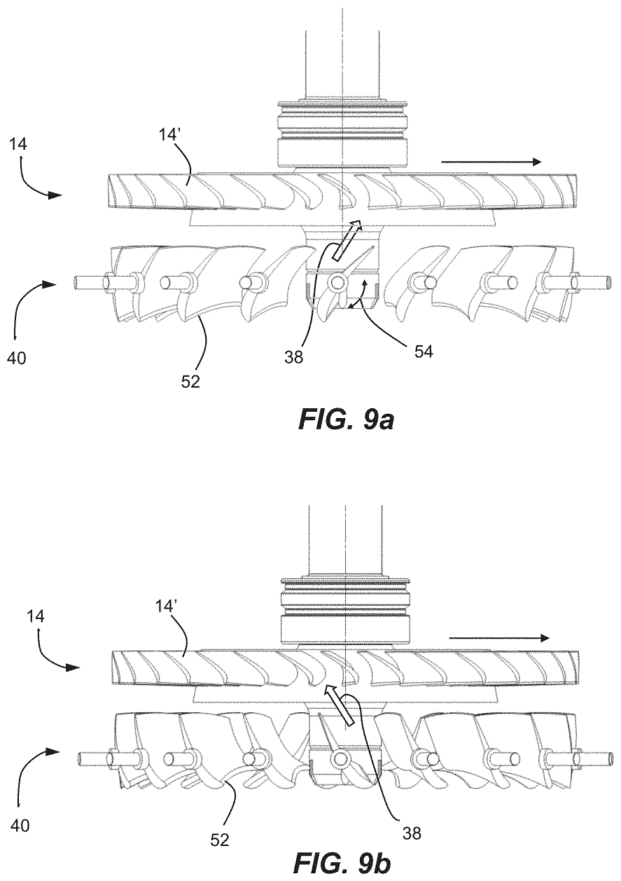

Referring to FIGS. 4, 5a, 6a, 7a and 8a, with the second spline coupling 76.2 engaging the hub shaft 114 to the spur gear 112, rotation of the drive shaft 116 of the variable-vane actuator 56 and the associated hub shaft 114 causes a rotation of the spur gear 112, resulting in a rotation of both the external ring-gear sector 110 and the axial ring gear 106 about the longitudinal axis 108 of the power turbine 14, which causes a rotation of each of the plurality of variable nozzle vanes 52 about the corresponding associated axis of rotation 64 thereof, so as to position each of the plurality of variable nozzle vanes 52 to provide for normal metering/directing the exhaust gases 38 onto the blades 14′ of the power turbine 14 responsive to rotational positioning by the variable-vane actuator 56, for example, as illustrated in FIG. 9a.

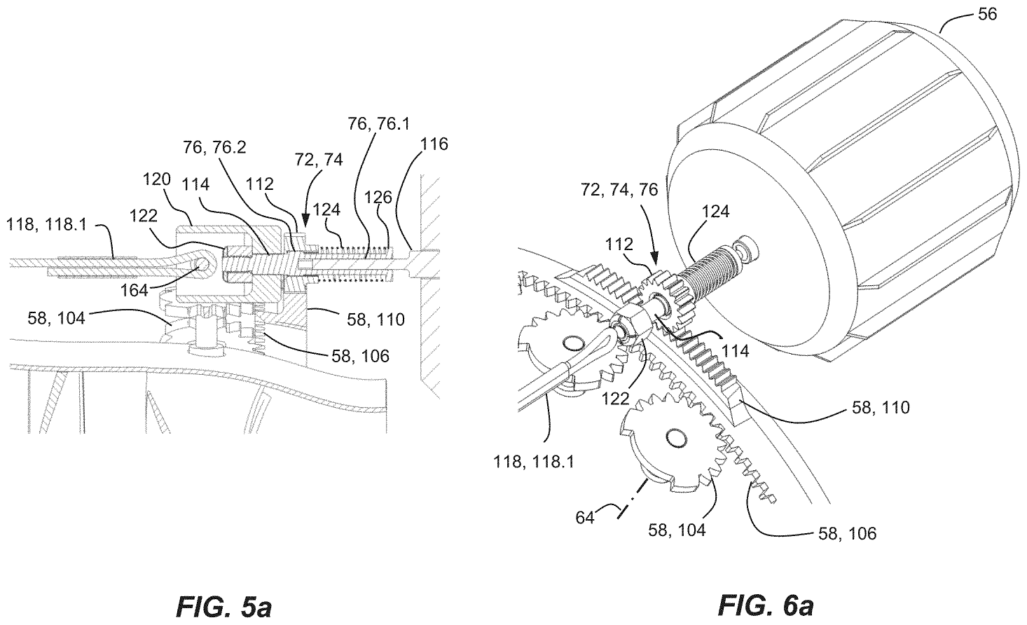

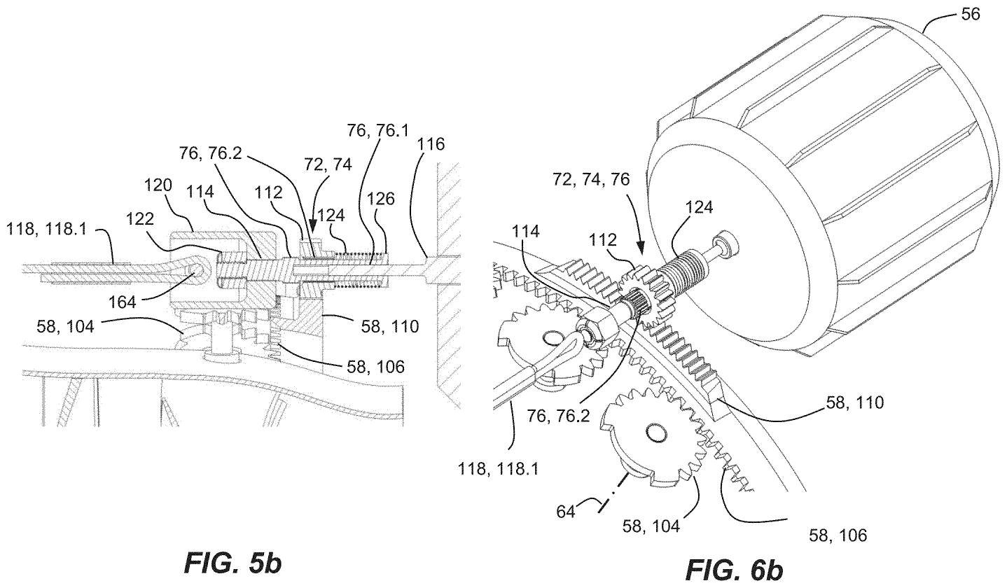

Referring to FIGS. 4, 5b, 6b, 7b and 8b, with the second spline coupling 76.2 between the hub shaft 114 and the spur gear 112 disengaged in response to an axial displacement of the swivel 120 responsive to tension in the control cable 118, the rotation of both the external ring-gear sector 110 and the axial ring gear 106 about the longitudinal axis 108 of the power turbine 14, and the associated rotation of each of the plurality of variable nozzle vanes 52 about the corresponding associated axis of rotation 64 thereof, is independent of the variable-vane actuator 56, but instead, responsive to a biasing element 66 that is operative between the axial ring gear 106 and a mechanical ground 128, for example, a tension spring 68, 68′ operative between the axial ring gear 106 and a mechanical ground strut 128, 128′ depending from the outer wall 96 of the duct 98 that is relatively fixed with respect to the gas-turbine engine 12. The biasing element 66/tension spring 68, 68′ acts to bias the rotational position of the axial ring gear 106, so that the rotational position of each of the plurality of variable nozzle vanes 52 are in turn biased towards the corresponding overspeed-mitigating rotational position via the associated nozzle-vane-angle control mechanism 58, for example, as shown in the configuration illustrated in FIG. 9b which provides for generating relatively-reverse torque on the power turbine 14 relative to normal operation of the gas-turbine engine 12. With the second spline coupling 76.2 engaged between the hub shaft 114 and the spur gear 112 as illustrated in FIGS. 5a and 6a, the biasing force from the biasing element 66 will act to either reinforce or oppose the drive torque from the variable-vane actuator 56, the latter of which has sufficient authority to overcome the effect thereof.

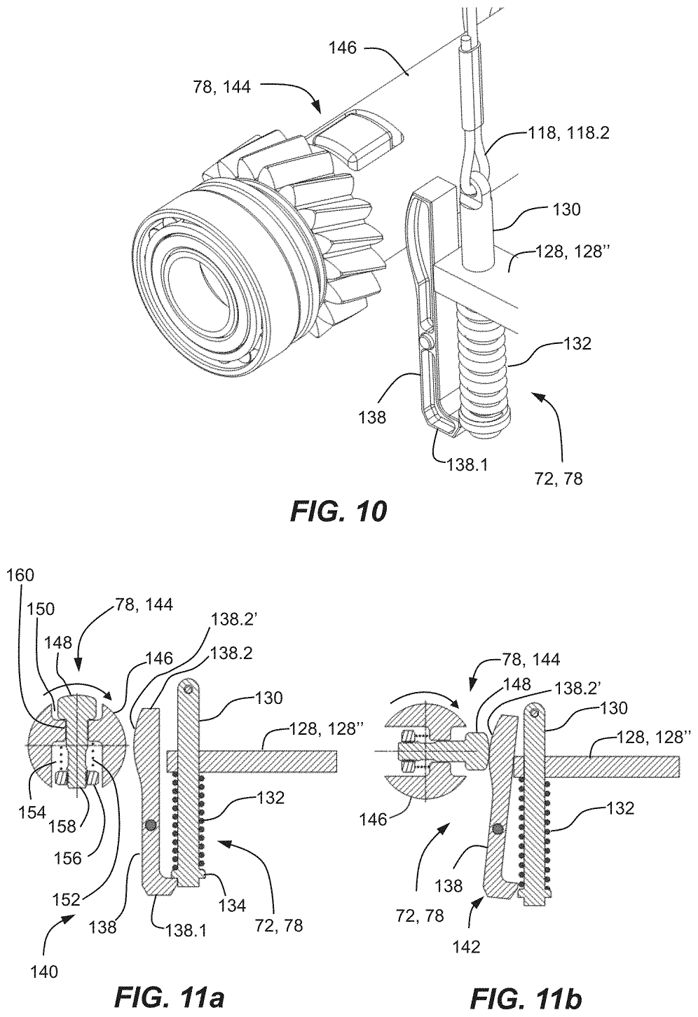

Referring to FIGS. 10, 11a and 11b, in accordance with the first embodiment of the third aspect gas-turbine-engine overspeed protection system 10, 10.3, 10.3′, the associated decoupling mechanism 72 incorporates a mechanically-actuated trigger system 78 that provides for generating a tension in the above-described control cable 118 responsive to an overspeed condition of the power turbine 14, which then provides for disengaging the second spline coupling 76.2 so as to provide for the associated biasing element 66, 68′ to cause each of the plurality of variable nozzle vanes 52 to be rotated to a corresponding associated overspeed-mitigating rotational position. More particularly, the mechanically-actuated trigger system 78 incorporates a spring-biased plunger 130 that is operatively coupled to the second end 118.2 of the control cable 118 so as to provide for applying a tension to the control cable 118, wherein the spring-bias of the spring-biased plunger 130 is provided by a compression spring 132 operative between a mechanical ground strut 128, 128″ and a flange 134 depending from an end of the spring-biased plunger 130, with the mechanical ground strut 128, 128″ depending from a hub 100 portion of an outlet duct 136 downstream of the power turbine 14 and relatively fixed with respect to the gas-turbine engine 12, as illustrated in FIG. 2a. The mechanically-actuated trigger system 78 further incorporates a trigger latch 138 that is pivoted from the mechanical ground strut 128, 128″ and incorporates a latch end 138.1 that—when the trigger latch 138 is in a first rotational position 140 illustrated in FIG. 11a—provides for engaging with the flange 134 of the spring-biased plunger 130 so as to retain the compression spring 132 in a compressed state so as to prevent the control cable 118 from being tensioned thereby. A second end 138.2 of the trigger latch 138 incorporates a follower surface 138.2′ by which the trigger latch 13 can rotated to a second rotational position 142 responsive to a mechanical rotational-speed sensor 144 operatively associated with either an output shaft 146 of the power turbine 14, or another shaft driven thereby.

In accordance with one set of embodiments, the mechanical rotational-speed sensor 144 incorporates a spring-biased mass 148 that is radially biased within a first socket 150 in the output shaft 146 by a compression spring 152 operative within a second socket 154 in the output shaft 146, wherein the second socket 154 is radially opposed to the first socket 150, and the compression spring 152 is operative between the base of the second socket 154 and a spring retainer 156 on the end of a stem shaft portion 158 of the spring-biased mass 148 that extends through a bore 160 in a portion of the output shaft 146 between the first 150 and second 154 sockets. As the rotational speed of the power turbine 14 increases, the net centrifugal force on the spring-biased mass 148 increases, causing a radially-outboard displacement of the spring-biased mass 148 and an associated compression of the compression spring 152 until the associated compressive spring force balances the net centrifugal force. The components of the mechanical rotational-speed sensor 144 and the geometry and relative position of the mechanically-actuated trigger system 78 are configured so that when the rotational speed of the power turbine 14 increase to an associated overspeed condition, the radial displacement of the spring-biased mass 148 becomes sufficient to sufficiently engage the follower surface 138.2′ of the trigger latch 138 to cause the trigger latch 138 to rotate to the second rotational position 142 illustrated in FIG. 11b, and thereby release the spring-biased plunger 130 to generate tension in the control cable 118 responsive to the associated compression spring 132, wherein the control cable 118 is routed over a cable guide 162 illustrated in FIG. 2a that depends from the hub 100 portion of the outlet duct 136 downstream of the power turbine 14 so as to provide for transmitting the cable tension to the first end 118.1 of the control cable 118 that is operatively coupled to the swivel 120 of the associated decoupling mechanism 72.

Referring to FIGS. 5a, 6a, 7a, 8a, 9a, 10 and 11a, during normal operation of the gas-turbine engine 12 with the power turbine 14 not experiencing an overspeed condition, i.e. with the rotational speed of the power turbine 14 not sufficient to trigger the mechanically-actuated trigger system 78, the rotational position 54 of each variable nozzle vane 52 is controlled by the variable-vane actuator 56 acting through the associated nozzle-vane-angle control mechanism 58, with the second spline coupling 76.2 providing for engagement of the drive shaft 116 with the associated spur gear 112 of the spline-shaft-driven gear mechanism 74.

Referring to FIGS. 5b, 6b, 7b, 8b, 9b and 11b, responsive to an overspeed condition of the power turbine 14, i.e. with the rotational speed of the power turbine 14 sufficient to trigger the mechanically-actuated trigger system 78, tension in the control cable 118 responsive to the compression spring 132 acting on the spring-biased plunger 130 of the mechanically-actuated trigger system 78 is applied to the swivel 120 of the decoupling mechanism 72 via an associated coupling pin 164, wherein the swivel 120 then acts against the retaining nut 122 at an end of the hub shaft 114—and against a retaining force from the compression spring 124 acting against the flange 126 at the opposing end of the hub shaft 114,—causing the second spline coupling 76.2 to become disengaged, thereby disengaging the drive shaft 116 of the variable-vane actuator 56 from the spur gear 112 of the spline-shaft-driven gear mechanism 74, so as to enable the tension spring 68, 68′ of the associated biasing element 66 to act on the axial ring gear 106 and cause—via the associated nozzle-vane-angle control mechanism 58—the rotational position 54 of each variable nozzle vane 52 to be biased towards the associated overspeed-mitigating rotational position, which provides for reducing or reversing the torque on the power turbine 14 from the exhaust gases 38 and as a result, cause the power turbine 14 to decelerate to safe operating speed. Following a triggering of the mechanically-actuated trigger system 78, the associated trigger latch 138 may be reset to a latched condition, i.e. in the first rotational position 140, so as to provide for subsequently mitigating against another overspeed condition after operation of the gas-turbine engine 12 is resumed.

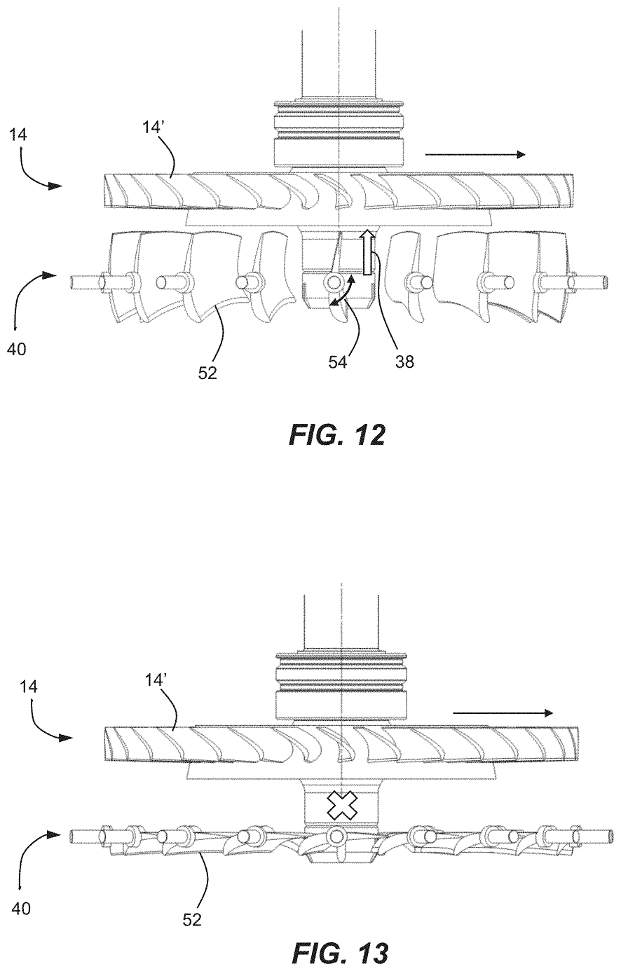

Alternatively, the overspeed-mitigating rotational position of the one or more variable nozzle vanes 52 could be configured as a relatively-open condition, for example, as illustrated in FIG. 12; or as a relatively-closed position, for example, as illustrated in FIG. 13.

A method of controlling a variable-vane turbine nozzle upstream of a turbine of a gas-turbine engine may include: a) biasing a rotational position of at least one variable-vane of the variable-vane turbine nozzle towards a corresponding rotational position that will mitigate against an overspeed condition of the turbine during operation of the gas-turbine engine; b) during the operation of the gas-turbine engine and independent of the operation of biasing the rotational position of the at least one variable-vane, when the turbine is operating at a rotational speed that is less than an overspeed threshold, independently controlling the rotational position of the at least one variable-vane of the variable-vane turbine nozzle using a variable-vane actuator operatively coupled to the at least one variable-vane of the variable-vane turbine nozzle; and c) responsive to the rotational speed of the turbine in excess of the overspeed threshold, releasing the operative coupling of the variable-vane actuator to the at least one variable-vane of the variable-vane turbine nozzle so as to provide for the at least one variable-vane of the variable-vane turbine nozzle to be repositioned towards the corresponding rotational position that will mitigate against the rotational speed of the turbine otherwise exceeding the overspeed threshold responsive to the operation of biasing the rotational position of the at least one variable-vane. For example, the operation of biasing the rotational position of the at least one variable-vane may provide for either biasing the rotational position of the at least one variable-vane in a relatively-open rotational position; biasing the rotational position of the at least one variable-vane in a rotational position that provides for the turbine to generate either a reverse torque or a relatively-reduced positive torque sufficient to prevent the overspeed condition of the turbine during the operation of the gas-turbine engine; or biasing the rotational position of the at least one variable-vane in a relatively-closed rotational position. The variable-vane turbine nozzle may incorporate at least one mechanical stop that provides for limiting the rotational position of the at least one variable-vane responsive to the operation of biasing the rotational position of the at least one variable-vane. The operation of biasing the rotational position of the at least one variable-vane may be responsive to either a) a biasing force generated by a spring and operatively coupled to the at least one variable-vane, b) a biasing force generated by a fluid-powered actuator and operatively coupled to the at least one variable-vane, or c) an aerodynamic biasing force operating on the at least one variable-vane during operation of the gas-turbine engine. The variable-vane actuator may be operatively coupled to the at least one variable-vane either a) with a spline-shaft-driven gear mechanism, and the operation of releasing the operative coupling of the variable-vane actuator to the at least one variable-vane comprises disconnecting at least one spline coupling of the spline-shaft-driven gear mechanism; b) with a releasable mechanical clutch and the operation of releasing the operative coupling of the variable-vane actuator to the at least one variable-vane comprises disconnecting the releasable mechanical clutch; c) with a releasable electromechanical clutch by which the associated operative coupling is via an associated first magnetic field, for example, either i) generated responsive to a holding current in a corresponding at least one coil wherein the operation of releasing the operative coupling of the variable-vane actuator to the at least one variable-vane comprises interrupting the holding current, or ii) generated by a permanent magnet wherein the operation of releasing the operative coupling of the variable-vane actuator to the at least one variable-vane comprises at least partially opposing the associated first magnetic field generated by the permanent magnet, with a corresponding associated second magnetic field; or d) with at least one frangible link, and the operation of releasing the operative coupling of the variable-vane actuator to the at least one variable-vane comprises severing the at least one frangible link, for example, using an associated at least one pyrotechnic device. The determination of whether the rotational speed of the turbine is in excess of the overspeed threshold may be automatically responsive to mechanically sensing the rotational speed of the turbine, for example, by rotating a spring-biased mass operatively coupled to a shaft rotating at a rotational speed responsive to the rotational speed of the turbine, and activating a trigger mechanism responsive to a radial position of the spring-biased mass relative to a rotational axis of the shaft; or responsive to a measurement of a rotational speed responsive to the rotational speed of the turbine. In accordance with one set of embodiments, the operative coupling of the variable-vane actuator to the at least one variable-vane is resettable following a decoupling thereof responsive to the overspeed condition.

A gas-turbine-engine overspeed protection system may include a. a variable-vane turbine nozzle, wherein the variable-vane turbine nozzle incorporates a plurality of variable nozzle vanes; b. a nozzle-vane-angle control mechanism, wherein the nozzle-vane-angle control mechanism provides for controlling a corresponding rotational angle of each of the plurality of variable nozzle vanes; c. a variable-vane actuator, wherein in a first mode of operation, the variable-vane actuator is operatively coupled to the plurality of variable nozzle vanes via the nozzle-vane-angle control mechanism so as to provide for controlling the corresponding rotational angle of each of the plurality of variable nozzle vanes and thereby control a direction of a stream of exhaust gases exiting the variable-vane turbine nozzle and subsequently impinging on a turbine of the gas-turbine engine downstream of the variable-vane turbine nozzle, and in a second mode of operation, the variable-vane actuator is operatively decoupled from the plurality of variable nozzle vanes, and the corresponding rotational angle of each of the plurality of variable nozzle vanes is biased in a rotational direction that provides for mitigating against an overspeed condition of the turbine downstream of the variable-vane turbine nozzle, wherein a rotational position of at least one variable nozzle vane of the plurality of variable nozzle vanes is biased responsive to at least one biasing force selected from the group consisting of an aerodynamic force acting on the at least one variable nozzle vane responsive to a geometry of the at least one variable nozzle vane, a spring force acting on either the nozzle-vane-angle control mechanism or the at least one variable nozzle vane, and a fluid-powered force acting on either the nozzle-vane-angle control mechanism or the at least one variable nozzle vane; and d. a decoupling mechanism, wherein the decoupling mechanism provides for decoupling the variable-vane actuator from the plurality of variable nozzle vanes in accordance with the second mode of operation, and the decoupling mechanism is actuated when a rotational speed of or responsive to the turbine exceeds a corresponding overspeed threshold. For example, the at least one biasing force if otherwise unimpeded may act either a) in a direction that provides for relatively-opening the plurality of variable nozzle vanes; b) in a direction that provides for positioning the plurality of variable nozzle vanes to cause the turbine to generate either a reverse torque or a relatively-reduced positive torque sufficient to prevent the overspeed condition of the turbine during the operation of the gas-turbine engine; or c) in a direction that provides for relatively-closing the plurality of variable nozzle vanes. The gas-turbine-engine overspeed protection system may further include a mechanical stop that provides for defining a rotational position limit of the plurality of variable nozzle vanes responsive to the at least one biasing force. The gas-turbine-engine overspeed protection system may further include a biasing element is operative between the nozzle-vane-angle control mechanism and a mechanical ground, and wherein the biasing element either generates the spring force or generates the fluid-powered force. In accordance with one set of embodiments, at least one variable nozzle vane of the plurality of variable nozzle vanes is shaped and configured so that a center of aerodynamic pressure acting on the at least one variable nozzle vane in relation to a rotational axis of the at least one variable nozzle vane acts to rotate the at least one variable nozzle vane in a direction responsive to the at least one biasing force. In accordance with one set of embodiments, the turbine is a power turbine of the gas-turbine engine. The gas-turbine-engine overspeed protection system may be incorporated in a gas-turbine engine that further includes a gasifier spool incorporating a compressor and a gasifier turbine operatively coupled to one another by an associated spool shaft, wherein the power turbine provides for driving a load external of the gas-turbine engine, the variable-vane turbine nozzle is located downstream of the gasifier turbine, and the gasifier spool provides for driving or being driven by either a fluid machine or an electrical machine. In one set of embodiments, the variable-vane actuator may be operatively coupled to the at least one variable nozzle vane with a spline-shaft-driven gear mechanism, wherein the decoupling mechanism comprises at least one spline coupling of the spline-shaft-driven gear mechanism. In other sets of embodiments, the decoupling mechanism may incorporate either a) a releasable mechanical clutch; b) a releasable electromechanical clutch that provides for operatively coupling the variable-vane actuator to the plurality of variable nozzle vanes via an associated first magnetic field, wherein i) the releasable electromechanical clutch incorporates at least one coil that provides for generating the associated first magnetic field responsive to a holding current, and an interruption of the holding current provides for decoupling the variable-vane actuator from the plurality of variable nozzle vanes, or ii) the releasable electromechanical clutch incorporates at least one permanent magnet that provides for generating the associated first magnetic field, and the decoupling mechanism further incorporates at least one coil that provides for generating a second magnetic field in opposition to the first magnetic field, so as to provide for decoupling the variable-vane actuator from the plurality of variable nozzle vanes; c) at least one frangible link that provides for operatively coupling the variable-vane actuator to the plurality of variable nozzle vanes, and a severing of the at least one frangible link provides for decoupling the variable-vane actuator from the plurality of variable nozzle vanes, for example, responsive to activation of a corresponding associated at least one pyrotechnic device; d) a trigger system that is mechanically responsive to a rotational speed of the turbine, for example, wherein the trigger system incorporates a spring-biased mass operatively coupled to a shaft rotating at a rotational speed responsive to a rotational speed of the turbine during operation of the gas-turbine engine, and a trigger mechanism responsive to a radial position of the spring-biased mass relative to a rotational axis of the shaft; or a rotational speed sensor that generates a rotational speed signal responsive to a rotational speed of the turbine, and a controller operatively coupled to the rotational speed sensor, wherein the controller provides for generating a decoupling actuation signal responsive to a comparison of the rotational speed signal with a corresponding overspeed threshold, wherein the decoupling actuation signal provides for actuating the decoupling mechanism so as to provide for decoupling the variable-vane actuator from the plurality of variable nozzle vanes. In accordance with one set of embodiments, following an actuation thereof, the decoupling mechanism is resettable so as to provide for operating the gas-turbine engine to generate shaft power with the turbine.

While specific embodiments have been described in detail in the foregoing detailed description and illustrated in the accompanying drawings, those with ordinary skill in the art will appreciate that various modifications and alternatives to those details could be developed in light of the overall teachings of the disclosure. It should be understood, that any reference herein to the term “or” is intended to mean an “inclusive or” or what is also known as a “logical OR”, wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C), (B, C), and (A, B, C); and so on if additional elements are listed. Furthermore, it should also be understood that the indefinite articles “a” or “an”, and the corresponding associated definite articles “the” or “said”, are each intended to mean one or more unless otherwise stated, implied, or physically impossible. Yet further, it should be understood that the expressions “at least one of A and B, etc.”, “at least one of A or B, etc.”, “selected from A and B, etc.” and “selected from A or B, etc.” are each intended to mean either any recited element individually or any combination of two or more elements, for example, any of the elements from the group consisting of “A”, “B”, and “A AND B together”, etc. Yet further, it should be understood that the expressions “one of A and B, etc.” and “one of A or B, etc.” are each intended to mean any of the recited elements individually alone, for example, either A alone or B alone, etc., but not A AND B together. Furthermore, it should also be understood that unless indicated otherwise or unless physically impossible, that the above-described embodiments and aspects can be used in combination with one another and are not mutually exclusive. Accordingly, the particular arrangements disclosed are meant to be illustrative only and not limiting as to the scope of the invention, which is to be given the full breadth of the appended claims, and any and all equivalents thereof.

What is claimed is:

1. A gas-turbine-engine overspeed protection system, comprising:
a. a variable-vane turbine nozzle, wherein said variable-vane turbine nozzle incorporates a plurality of variable nozzle vanes;
b. a nozzle-vane-angle control mechanism, wherein said nozzle-vane-angle control mechanism provides for controlling a corresponding rotational angle of each of said plurality of variable nozzle vanes;
c. a variable-vane actuator, wherein in a first mode of operation, said variable-vane actuator is operatively coupled to said plurality of variable nozzle vanes via said nozzle-vane-angle control mechanism so as to provide for controlling said corresponding rotational angle of each of said plurality of variable nozzle vanes and thereby control a direction of a stream of exhaust gases exiting said variable-vane turbine nozzle and subsequently impinging on a turbine of the gas-turbine engine downstream of said variable-vane turbine nozzle, and in a second mode of operation, said variable-vane actuator is operatively decoupled from said plurality of variable nozzle vanes, and said corresponding rotational angle of each of said plurality of variable nozzle vanes is biased in a rotational direction that provides for mitigating against an overspeed condition of said turbine downstream of said variable-vane turbine nozzle, wherein a rotational position of at least one variable nozzle vane of said plurality of variable nozzle vanes is biased responsive to at least one biasing force selected from the group consisting of an aerodynamic force acting on said at least one variable nozzle vane responsive to a geometry of said at least one variable nozzle vane, a spring force acting on either said nozzle-vane-angle control mechanism or said at least one variable nozzle vane, and a fluid-powered force acting on either said nozzle-vane-angle control mechanism or said at least one variable nozzle vane; and
d. a decoupling mechanism, wherein said decoupling mechanism provides for decoupling said variable-vane actuator from said plurality of variable nozzle vanes in accordance with said second mode of operation, and said decoupling mechanism is actuated when a rotational speed of or responsive to said turbine exceeds a corresponding overspeed threshold.

2. A gas-turbine-engine overspeed protection system as recited in claim 1, wherein said at least one biasing force if otherwise unimpeded acts in a direction that provides for relatively-opening said plurality of variable nozzle vanes.

3. A gas-turbine-engine overspeed protection system as recited in claim 1, wherein said at least one biasing force if otherwise unimpeded acts in a direction that provides for positioning said plurality of variable nozzle vanes to cause said turbine to generate either a reverse torque or a relatively-reduced positive torque sufficient to prevent said overspeed condition of said turbine during the operation of said gas-turbine engine.

4. A gas-turbine-engine overspeed protection system as recited in claim 1, wherein said at least one biasing force if otherwise unimpeded acts in a direction that provides for relatively-closing said plurality of variable nozzle vanes.

5. A gas-turbine-engine overspeed protection system as recited in claim 1, further comprising a mechanical stop that provides for defining a rotational position limit of said plurality of variable nozzle vanes responsive to said at least one biasing force.

6. A gas-turbine-engine overspeed protection system as recited in claim 1, further comprising a biasing element, wherein said biasing element is operative between said nozzle-vane-angle control mechanism and a mechanical ground, and said biasing element generates said spring force.

7. A gas-turbine-engine overspeed protection system as recited in claim 1, further comprising a biasing element, wherein said biasing element is operative between said nozzle-vane-angle control mechanism and a mechanical ground, and said biasing element generates said fluid-powered force.

8. A gas-turbine-engine overspeed protection system as recited in claim 1, wherein at least one variable nozzle vane of said plurality of variable nozzle vanes is shaped and configured so that a center of aerodynamic pressure acting on said at least one variable nozzle vane in relation to a rotational axis of said at least one variable nozzle vane acts to rotate said at least one variable nozzle vane in a direction responsive to said at least one biasing force.

9. A gas-turbine-engine overspeed protection system as recited in claim 1, wherein said turbine is a power turbine of said gas-turbine engine.

10. A gas-turbine-engine overspeed protection system as recited in claim 1, wherein said variable-vane actuator is operatively coupled to said at least one variable nozzle vane with a spline-shaft-driven gear mechanism, and said decoupling mechanism comprises at least one spline coupling of said spline-shaft-driven gear mechanism.

11. A gas-turbine-engine overspeed protection system as recited in claim 1, wherein said decoupling mechanism comprises a releasable mechanical clutch.

12. A gas-turbine-engine overspeed protection system as recited in claim 1, wherein said decoupling mechanism comprises a releasable electromechanical clutch that provides for operatively coupling said variable-vane actuator to said plurality of variable nozzle vanes via an associated first magnetic field.

13. A gas-turbine-engine overspeed protection system as recited in claim 12, wherein said releasable electromechanical clutch comprises at least one coil that provides for generating said associated first magnetic field responsive to a holding current, and an interruption of said holding current provides for decoupling said variable-vane actuator from said plurality of variable nozzle vanes.

14. A gas-turbine-engine overspeed protection system as recited in claim 12, wherein said releasable electromechanical clutch comprises at least one permanent magnet that provides for generating said associated first magnetic field, and said decoupling mechanism further comprises at least one coil that provides for generating a second magnetic field in opposition to said first magnetic field, so as to provide for decoupling said variable-vane actuator from said plurality of variable nozzle vanes.

15. A gas-turbine-engine overspeed protection system as recited in claim 1, wherein said decoupling mechanism comprises at least one frangible link that provides for operatively coupling said variable-vane actuator to said plurality of variable nozzle vanes, and a severing of said at least one frangible link provides for decoupling said variable-vane actuator from said plurality of variable nozzle vanes.

16. A gas-turbine-engine overspeed protection system as recited in claim 15, wherein said at least one frangible link is severed responsive to activation of a corresponding associated at least one pyrotechnic device.

17. A gas-turbine-engine overspeed protection system as recited in claim 1, wherein said decoupling mechanism comprises a trigger system that is mechanically responsive to a rotational speed of said turbine.

18. A gas-turbine-engine overspeed protection system as recited in claim 17, wherein said trigger system comprises:
a. a spring-biased mass operatively coupled to a shaft rotating at a rotational speed responsive to a rotational speed of said turbine during operation of said gas-turbine engine; and
b. a trigger mechanism responsive to a radial position of said spring-biased mass relative to a rotational axis of said shaft.

19. A gas-turbine-engine overspeed protection system as recited in claim 1, wherein said decoupling mechanism comprises:
a. a rotational speed sensor that generates a rotational speed signal responsive to a rotational speed of said turbine; and
b. a controller operatively coupled to said rotational speed sensor, wherein said controller provides for generating a decoupling actuation signal responsive to a comparison of said rotational speed signal with a corresponding overspeed threshold, wherein said decoupling actuation signal provides for actuating said decoupling mechanism so as to provide for decoupling said variable-vane actuator from said plurality of variable nozzle vanes.

20. A gas-turbine-engine overspeed protection system as recited in claim 1, wherein following an actuation thereof, said decoupling mechanism is resettable so as to provide for operating said gas-turbine engine to generate shaft power with said turbine.

21. A gas-turbine-engine overspeed protection system as recited in claim 9, wherein the gas-turbine-engine overspeed protection system is incorporated in a gas-turbine engine that further comprises a gasifier spool comprising a compressor and a gasifier turbine operatively coupled to one another by an associated spool shaft, said power turbine provides for driving a load external of said gas-turbine engine, said variable-vane turbine nozzle is located downstream of said gasifier turbine, and said gasifier spool provides for driving or being driven by either a fluid machine or an electrical machine.
